(19) United States
(12) Patent Application Publication
(10) Pub. No.: US 2026/0110353 A1
(43) Pub. Date: Apr. 23, 2026

(54) TOOTH FOR A TOOTHED TORQUE TRANSMISSION ASSEMBLY, AND METHOD FOR MANUFACTURING SUCH A TOOTH

(71) Applicant: Flender GmbH, 46395 Bocholt (DE)

(72) Inventors: Klaus Dünck-Kerst, BOCHOLT (DE); JOHANNES VRIESEN, Bocholt (DE); THOMAS JACOB, Bocholt (DE)

(73) Assignee: Flender GmbH, 46395 Bocholt (DE)

(21) Appl. No.: 19/160,261

(22) PCT Filed: Feb. 23, 2024
(86) PCT No.: PCT/EP2024/054665

§ 371 Date: Aug. 27, 2025

(30) Foreign Application Priority Data
Feb. 28, 2023 (EP) 23159105.8

(51) Int. Cl. F16H 55/08; B23F 1/02; F03D 15/10; F16H 57/00

(52) U.S. Cl. CPC F16H 55/0806; B23F 1/02; F03D 15/10; F05B 2260/4031; F05B 2260/96; F16H 57/0006

(57) ABSTRACT

A tooth for a toothed torque transmission assembly includes a tooth flank designed for torque exchange with a counter flank of a meshing partner. The tooth flank includes a periodically extending tooth flank correction including a sinusoidal corrugation having a locally extending period length T, wherein a development of the sinusoidal corrugation of the periodically extending tooth flank correction defines a center line. The periodic tooth flank correction is overlaid with a spatial microstructure having a local maxima and/or a local minima and a shortest distance t of t<T/2 between the local maxima and/or the local minima with respect to the center line. A formation of the microstructure is dimensioned to generate additional structure-borne sound in running operation of the torque transmission assembly to mask a tonality in the emitted structure-borne sound.

The invention relates to a tooth for a toothed torque transmission assembly and a method for manufacturing such a tooth, with the aid of which a toothed engagement in the torque transmission assembly, in particular a wind power gear, can take place with improved noise. The invention furthermore relates to a toothed element having such a tooth, a wind power gear having such a tooth and/or such a toothed element, a computer program product for carrying out the method, and a data agglomerate for additive manufacturing and/or simulation of the tooth and/or the toothed element.

Providing a standardized tooth of a gear wheel pair with a periodic corrugation on its tooth flank is known from EP 2 774 709 A2, in order to reduce oscillations arising due to irregularities in the tooth engagement of the gear wheel pair under load, as a result of which a uniformity in the tooth engagement is increased and running noises are reduced.

Providing tooth flanks of gear wheels with regularly arranged depressions is known from DE 28 48 206 A1, in order to achieve the most consistent possible lubricating film between engaged tooth flanks, as a result of which noise generation can be avoided.

Providing tooth flanks of gear wheels with irregularly arranged depressions is known from US 2010/0071495 A1, in order to achieve the greatest possible lubricating film between engaged tooth flanks, as a result of which wear can be reduced.

There is a continuous demand for reducing noise emissions in torque transmission units, in particular transmissions, which are disturbing to humans.

It is the object of the invention to disclose measures which enable a reduction of noise emissions disturbing to humans in torque transmission units.

The object is achieved by a tooth having the features of claim 1, a toothed element having the features of claim 8, a holding tool having the features of claim 9, a wind power gear having the features of claim 10, a method having the features of claim 11, a computer program product having the features of claim 14, and a data agglomerate having the features of claim 15. Preferred configurations are specified in the dependent claims and in the following description and may in each case individually or in combination represent an aspect of the invention. If a feature is presented in combination with another feature, this serves only for simplified presentation of the invention and is in no way intended to mean that said feature cannot also be a refinement of the invention without the other feature, wherein the scope of protection of the invention is defined by the independent claims.

One aspect of the invention relates to a tooth for a toothed torque transmission assembly, having a tooth flank for torque exchange with a counter flank of a meshing partner, wherein the tooth flank has a periodically extending tooth flank correction having a sinusoidal corrugation having a locally extending period length T. wherein the periodic tooth flank correction is overlaid with a spatial microstructure, wherein the microstructure has local maxima and/or local minima as well as a shortest distance t of t<T/2 between the local maxima and/or the local minima, In particular, the formation of the microstructure is dimensioned to generate additional structure-borne sound in running operation of the torque transmission assembly, preferably to mask a tonality in the emitted structure-borne sound.

The periodically extending tooth flank correction can in particular represent a standardized tooth flank correction according to ISO 21771[:2007], which forms a sinusoidal corrugation along the surface of the tooth flank. This, generally standardized, tooth flank correction is additionally overlaid with the microstructure, however, which is subordinated to the periodic tooth flank correction, however, The periodic tooth flank correction is not made unrecognizable by the microstructure, but rather remains well recognizable. The microstructure can preferably form, in the scope of the tolerance fields provided for this tooth flank correction, additional peaks and/or valleys in the otherwise resulting substantially three-dimensionally extending surface of the tooth flank correction, which is fundamentally planar in the unwound representation, however. These peaks and/or valleys of the microstructure are in particular so strongly pronounced that they are greater than an intended roughness. At the same time, it is possible to have the peaks and valleys of the microstructure so weakly pronounced that boundary conditions for the formation of tooth flank correction permissible according to ISO 21771[:2007] are not infringed. In particular, the requirements for the carrying capacity of the tooth according to ISO 6336 are observed due to the superposition of the tooth flank correction with the microstructure. If a sectional image of a tooth having tooth flank correction and having microstructures is compared with a sectional image of an otherwise identical tooth having the identical tooth flank correction but without microstructures, a more strongly irregular, in particular jittery, course results for the surface course in the plane of section for the tooth having microstructures, comparable to an interference of superimposed waves.

In an independent invention, the tooth flank correction is not a periodically extending tooth flank correction, which has precisely one locally extending period length T, but rather a tooth flank correction permissible according to ISO 21771[2007], which in particular non-exclusively has to be a periodically extending tooth flank correction, which has precisely one locally extending period length T. The intended tooth flank correction can also be a non-periodic tooth flank correction and can in particular have any formation described in ISO 21771[:2007]. The microstructure can thus be superimposed on an arbitrary tooth flank correction defined according to ISO 21771[:2007]. This independent invention relates in particular to a tooth for a toothed torque transmission assembly, having a tooth flank for torque exchange with a counter flank of a meshing partner, wherein the tooth flank has a tooth flank correction according to ISO 21771[:2007], wherein the tooth flank correction is superimposed with a spatial microstructure, wherein in particular the microstructure has local maxima and/or local minima and a shortest distance t between the local maxima and/or local minima, wherein the tooth flank has a height H between a base of the tooth and a head of the tooth along a surface normal of the head, wherein 0.00001≤t/H≤0.10, in particular 0.0001≤1/H≤0.05, preferably 0.0005≤t/H≤0.01, and particularly preferably 0.001≤t/H≤0.005. This embodiment can be designed and refined as explained above and/or below.

In a further independent invention, no tooth flank correction is provided. The microstructure can thus be directly superimposed on a base shape of the tooth flank provided for teeth, without this base shape being modified by a tooth flank correction according to ISO 21771[:2007]. The tooth flank in this embodiment is based in particular on a straight-toothed or helical-toothed base shape of the tooth for evolvent teeth or cycloid teeth. This independent invention relates in particular to a tooth for a toothed torque transmission assembly, having a tooth flank for torque exchange with a counter flank of a meshing partner, wherein the tooth flank is based on a base shape intended for teeth, in particular evolvent teeth or cycloid teeth, wherein the base shape is overlaid by a spatial microstructure, wherein in particular a repeating pattern is formed by the microstructure by local maxima and/or local minima, wherein preferably the local maxima and/or local minima are arranged, in particular in an alternating manner, like a chessboard in rows and columns. This embodiment can be designed and refined as explained above and/or below.

It has been recognized that the sound pressure or the sound pressure level can be reduced by the standardized periodic tooth flank correction, but the remaining frequencies in the emitted structure-borne sound when teeth are engaged under load during a torque transmission in the toothed torque transmission assembly can emerge very clearly and clearly audible for humans. The main frequencies that occur in the emitted structure-borne sound with a specific tooth flank correction can be washed out by the microstructures and/or additional secondary frequencies can be generated, so that the main frequencies no longer stand out so clearly and unambiguously. The proportion of white noise in the emitted structure-borne sound is thus increased by the microstructures and the sound pressure of the emitted structure-borne sound is reduced to a lesser extent, if at all. It has been recognized that an increase of the white noise can mask and cover the perception of a specific frequency as noise in the hearing of a human. Although the sound pressure in the emitted structure-borne sound has hardly changed, the noise perception in the human hearing can be influenced by the washing-out of the main frequencies and the increase of the white noise, so that structure-borne sound emitted from teeth with tooth flank correction but without microstructures can be perceived as disturbing noise by a human, while structure-borne sound emitted from teeth with tooth flank correction and with microstructures is no longer perceived as disturbing noise in spite of comparable sound pressure. By way of the formation of the microstructure, in particular due to the selection of the distances of maxima and/or minima and also their height or depth, the main frequencies occurring in any case can be changed and/or masked and/or specific frequencies or frequency ranges can be intentionally generated with a defined bandwidth, as a result of which the extent of white noise in the emitted structure-borne sound can be increased. The increase of the white noise in the structure-borne sound emitted from the tooth with the aid of the microstructures enables a reduction of noise emissions disturbing to humans in torque transmission units.

It is possible in particular to mask a tonality in the emitted structure-borne sound of wind power plants by way of the tooth flank correction according to the invention, which deviates from the tooth flank correction according to ISO 21771[:2007]. The tonality in the emitted structure-borne sound is a frequency standing out from the frequency spectrum of the emitted structure-borne sound with respect its volume or its volume level, which can be determined according to the norm according to IEC 61400-11. In particular, only precisely one tonality is present in the standard base shape of the tooth with the tooth flank correction according to ISO 21771[:2007], wherein in principle two, three, four, or even more tonalities can also be present. In general, the number of the tonalities present is very low, in particular fewer than five, preferably fewer than three. Due to the tooth flank correction according to the Invention, this tonality can be washed out over a larger frequency range, Le. masked, by the additional white noise generated. The single tonality can thus no longer be resolved by a human as a single disturbing noise. Due to the masking of the tonality using the generated white noise around the frequency of the tonality, this tonality is perceived as less disturbing by humans. If the frequency band, determined according to IEC 61400-11, of an associated torque transmission assembly, in particular in a wind power plant, in operation is FFT-transformed (FFT: Fast Fourier Transform), a greater bandwidth results in the image range of the FFT for the tonality with the tooth flank correction according to the invention in comparison to the standard tooth flank correction, I.e. the frequency range around the frequency of the tonality is broader with the tooth flank correction according to the invention in comparison to the more sharply mapped tonality in the image range with the standard tooth flank correction. The white noise in the range of the tonality can possibly even reduce the amplitude of the frequency of the tonality by destructive interference. Noise generation is not to be prevented by the microstructure, but rather noises in the form of white noise are even to be intentionally generated in order not to reduce the noise level of the emitted structure-borne sound by the masking of occurring tonalities, but rather to reduce their perception as disturbing noise by humans. Instead of reducing the sound generation of structure-borne sound, the perception of the emitted structure-borne sound is adapted so as to be less disturbing in that the frequency spectrum of the emitted structure-borne sound is supplemented in a manner with further audible frequencies, which positively influences a frequency otherwise perceived as disturbing in its perception as disturbing noise for humans. The finding is utilized in this case that not only the volume, but also the specific frequency spectrum in an audible noise has a significant influence on the human perception of a noise as disturbing or not disturbing.

The tooth can be a, preferably integral, part of a gear wheel, a toothed rack, or another component which in a meshed state can exchange a torque with the meshing partner meshed with this tooth. The tooth in general has a base connected to a main body and a head facing away from the main body, wherein the base and the head are connected via the tooth flank intended for torque transmission in a specific direction. In particular, two tooth flanks acting in different directions are provided, which can exchange a torque with the meshing partner in the respective direction. The meshing partner preferably also has at least one tooth formed according to the invention. The base and the head can be connected to one another via end faces not intended for torque transmission. Particularly preferably, the periodically extending tooth flank correction and the spatial microstructure are only formed on those tooth flanks at which an exchange of a torque also takes place in the designated application, so that unnecessary machine effort can be saved.

The tooth flank correction is an intentional deviation of the tooth shape of the tooth, which without tooth flank correction is based on a base shape Intended for a specific type of teeth, for example evolvent teeth or cycloid teeth. A tooth flank correction is understood in particular as modifications of teeth as presented and standardized in ISO21771[:2007]. The tooth flank correction is distinguished by a formation which can be described by a comparatively simple mathematical formula, for example a sine function or polynomial function. For example, the tooth modification is designed as a waveform with respect to an unwound representation of the base shape of the tooth (“tooth flank development”), which has a constant period duration or frequency and a constant amplitude, due to which the waveform can be described by a simple sine function. The tooth modification designed as a waveform extends in particular along a straight propagation direction, which in the unwound representation of the base shape of the tooth extends non-curvedly and non-discontinuously. Transversely to the propagation direction, the waveform is generally formed identically in all sectional views in the unwound representation of the base shape of the tooth.

The formation of the microstructure can take place with respect to a development of the sinusoidal corrugation of the periodically extending tooth flank correction as a valley or depression and/or as a peak or protrusion. If the development of the sinusoidal corrugation of the periodically extending tooth flank correction defines a center line, it is possible that microstructures created by a material-removing machining method, for example laser machining, exclusively create depressions forming minima. Moreover, it is possible that exclusively protrusions forming maxima are created with respect to the center line defined by the development by an additive manufacturing method, such as sputtering. The microstructures preferably have both depressions forming minima and protrusions forming maxima, which are particularly preferably created by a chip-free shaping method, such as embossing. In particular, the microstructure has a plurality of sections delimited from one another and spaced apart from one another, each of which forms a depression or a protrusion, due to which in particular a structured surface results, but which sections are provided discontinuously and/or irregularly along imaginary lines. These sections have, for example, an area of 160 μm² to 740 μm², wherein preferably the area is in the order of magnitude of 800 μm² to 1200 μm², particularly preferably 1000 μm² to 3000 μm² or even higher, in order to be able to mask audible tonalities in the emitted structure-borne sound. Since the microstructure does not have to be optimized for improved lubrication, the depressions and protrusions of the microstructure have clearly distinguishable dimensions in comparison to surface structures designed for improved lubrication.

The microstructure can have, with respect to an unwound representation of the shape of the tooth resulting after the tooth flank correction (“tooth flank correction development”), a plurality of locally distributed local maxima and/or minima, which are arranged regularly or preferably irregularly in relation to one another. With respect to the tooth flank correction development, the maxima and minima can have different distances or deflections and/or can have distances of different sizes. The maxima and the minima of the microstructure, in contrast to a tooth flank correction designed as a waveform, are preferably arranged not only in a propagation direction, but rather in both surface directions of the tooth flank. The microstructure can in particular form a two-dimensional topology with respect to the tooth flank correction development. The maxima and/or minima of the microstructure are in particular larger in area and/or greater with respect to their deflection in relation to the tooth flank correction development than a typical roughness which results after the creation of the tooth flank correction. The microstructure does not represent a roughness of the tooth flank correction automatically resulting after the creation, but rather is intentionally induced by a further machining method in addition to the creation of the tooth flank correction. The machining method used to create the microstructure can certainly achieve, however, an arbitrarily or randomly distributed arrangement of maxima and/or minima and/or can achieve a lesser roughness than the machining method used to create the tooth flank correction. In particular, it is provided in the microstructure that a local positional maximum has a distance t in relation to a closest local minimum and/or in relation to a closest local maximum and the tooth flank has a height H between a base of the tooth and a head of the tooth along a surface normal of the head, wherein 0.00001≤t/H≤0.10, in particular 0.0001≤t/H≤0.05, preferably 0.0005≤t/H≤0.01, and particularly preferably 0.001≤V/H≤0.005.

The distance t is defined by a minimum distance of extreme values of the microstructure, wherein the extreme values observed can be maxima and/or minima. In an alternating arrangement of maxima and minima, the distance t is defined by the distance of the lowest point of the minimum and the highest point of the adjacent maximum. However, it is also possible that two maxima and/or two minima are arranged in succession with respect to a development of the base shape of the tooth or the tooth flank correction. In this case, the distance t is defined by the distance of the highest point of the two adjacent maxima or by the distance of the lowest point of the two adjacent minima. In formations of the microstructure in which the maximum and/or the minimum is not formed by a single point, but rather by a plateau, a line, or the like, the distance t is defined by the shortest route along a straight line which connects at least two points of the maximum or the minimum across a height difference.

The distance t is in particular less than a deformation of the tooth to be expected under load. The distance t is preferably less by at least a power of ten than a deformation of the tooth to be expected under load. In particular, 0.5 μm≤t≤25 μm, preferably 1 μm≤t≤20 μm, more preferably 5 μm≤t≤15 μm, and particularly preferably 8 μm≤t≤12 μm, for example t=10 μm±1 μm.

In particular, 0.00005≤t/T≤0.49, in particular 0.0001≤t/T≤0.05, preferably 0.0005≤t/T≤0.01, and particularly preferably 0.001≤t/T≤0.005. Local maxima and/or minima of the microstructure can thus be located by a factor of five, ten, or even more within a single period duration T of the tooth flank correction. Beats audible to a human can thus be avoided in the emitted structure-borne sound and the extent of white noise can be increased.

The tooth flank correction preferably has an amplitude A in the direction of a surface normal of the, in particular not tooth-flank corrected, tooth flank and the microstructure in relation to a center line of the tooth flank correction has a deflection a in the direction of a surface normal of the tooth flank, wherein 0.00005≤a/A≤0.50, In particular 0.0001≤a/A≤0.10, preferably 0.0005≤a/A≤0.05, and particularly preferably 0.001≤a/A≤0.01. The amplitude A of the tooth flank correction is determined in relation to the main body of the tooth without tooth flank correction and in the direction of the respective surface normal of this tooth along the observed course of the tooth flank correction. The amplitude of the tooth flank correction is preferably equal in the direction of the surface normal and against the surface normal and oscillates around a center line of the tooth flank correction which coincides with the surface of the tooth without tooth flank correction. The deflection of the microstructure, thus the height of the local maximum and/or the depth of the local minimum, in comparison to the tooth flank correction development is thus small, so that the technical effect of the tooth flank correction is not impaired. In addition, the minima of the microstructure can be sufficiently small that a lubricant, in particular lubricant oil, can easily adhere to the tooth flank due to adhesion and/or capillary effects. The maxima of the microstructure can be elastically deformed under load, as a result of which a damping effect and enhanced smooth running can be achieved.

The microstructure can have the/a deflection a in the direction of a surface normal of the tooth flank in relation to a tooth flank correction development and/or in relation to a tooth flank development, wherein in particular the deflection a is less than a deformation of the tooth to be expected under load. The deflection a is preferably less by at least a power of ten than a deformation of the tooth to be expected under load. In particular, 0.5 μm≤a≤25 μm, preferably 1 μm≤a≤20 μm, more preferably 5 μm≤a≤15 μm, and particularly preferably 8 μm≤a=12 μm, for example a=10 μm±1 μm. The maximum height of a maximum and/or the maximum depth of a minimum in relation to the unwound surface is preferably used as a reference height by way of the distance a to the respective unwound surface.

It is particularly preferably provided that the tooth flank correction and the microstructure extend uniformly in area both in the width direction and in the length direction of the tooth flank, in particular the entire tooth flank. The width direction extends parallel to a designated axis of rotation of an associated gear wheel, while the length direction extends from the tooth base to the tooth head. The width direction and the length direction are aligned essentially at right angles to one another. Partial surfaces of the tooth flank which can be delimited from one another and which can be distinguished from one another, for example, due to a different reflection behavior, are thus avoided. It is thus possible to prevent effects which can only be predicted with difficulty beforehand on the noise behavior from occurring due to a sudden change of the surface quality between two sections of the tooth flank.

In particular, a course of the microstructure over the tooth flank correction is formed aperiodically, In particular arbitrarily and/or randomly distributed. An oscillation caused by the microstructure itself, which could result in audible emitted structure-borne sound, can be avoided by the nonperiodic distribution of the maxima and minima of the microstructure. Instead, the extent of white noise can be increased.

It is preferably provided that if a tooth with microstructures is compared to an otherwise identical tooth without microstructures, a Fast Fourier Transform (“FFT”) of a structure-borne sound emitted from the tooth with microstructures, with otherwise identical torque transmission in the same toothed torque transmission assembly, has a greater bandwidth of the at least one frequency maximum, in particular a tonality, in the image range of the Fast Fourier Transform. The tooth according to the invention thus has a deviating acoustic property in comparison to a standard tooth which is not overlaid with a microstructure, which contains masking of the audible tonality due to an enlarged bandwidth of the tonality in the image range of the FFT achieved with the aid of the microstructure. The emitted structure-borne sound can be imaged by a frequency spectrum determined according to IEC 61400-11, which is observed in the image range of the FFT. Due to the greater bandwidth, in the tooth with microstructure, the lower and higher adjacent surrounding frequency lines, for example in a frequency range +/−100 Hz, of the observed frequency maxima of the main frequency are raised so that masking on the left and right side of the frequency maxima is increased. Additionally or alternatively, secondary frequencies are generated in addition to the main frequencies occurring even without microstructure due to the microstructure, wherein in particular the amplitude of the secondary frequency is significantly less, for example by a power of ten, than the amplitude of the closest main frequency in the image range. In particular, the secondary frequency also has a greater bandwidth than the main frequency without microstructure. Without microstructure, discrete frequencies superimposed on one another result in the structure-borne sound emitted from the tooth under load, which each appear in the image range of the FFT as a very narrow amplitude peak at a specific frequency having at most only very small bandwidth of the frequency. However, this frequency can be washed out by the microstructures, so that the bandwidth of the frequency broadens and slight deviations of this frequency result. The original main frequency, which still represents the maximum of the respective bandwidth, is thus less sharply separated and has stronger noise. The respective frequency is thus perceived as less disturbing by the human hearing.

The tooth flank is particularly preferably based on a straight-toothed or helical-toothed base shape for evolvent teeth or cycloid teeth. The superposition of the tooth flank correction with the microstructure can be applied to a variety of different base shapes of the tooth. A restriction to a specific base shape of the tooth is not required.

A further aspect of the invention relates to a toothed element, in particular a gear wheel or toothed rack, for a meshed torque transmission assembly having a plurality of teeth, which can be designed and refined as described above. At least two teeth are preferably formed differently from one another. In particular, it is provided that for at least one tooth flank of different teeth, microstructures formed differently with respect to their distance t and/or their deflection a are formed and/or the periodically extending tooth flank correction of these teeth is formed substantially differently, in particular with respect to the period length T and/or a phase offset between these teeth. The Increase of the white noise in the structure-borne sound emitted from the tooth of the toothed element with the aid of the microstructures enables a reduction of noise emissions disturbing to humans in torque transmission units.

In a further embodiment, a tooth indexing of the toothed element is variable in the circumferential direction. That is to say a distance between two teeth in the circumferential direction can differ. The difference in the circumferential direction is in particular less than 1° in the circumferential angle. A periodic noise behavior can thus be reduced, as a result of which the frequency spectrum in the emitted structure-borne sound and therefore also the extent of white noise can be increased.

In particular, the tooth flanks with differently formed microstructures have an essentially equal mean roughness Rₐ and/or an essentially equal square roughness R_{q}. It is thus possible that successive teeth of the toothed element have an at least slightly different noise behavior. In particular at high speeds, when the chronologically successive tooth engagements alternate rapidly, the extent of white noise can thus be further increased.

A further aspect of the invention relates to a wind power gear for a wind power plant, which is set up in particular in inhabited space, having at least one toothed element, which can be designed and refined as described above, Due to the increase of the white noise in the structure-borne sound emitted from the tooth with the aid of the microstructures, reducing noise emissions disturbing to humans in the wind power gear is enabled. It is thus possible to position a wind power plant closer to an inhabited space, without thereby disturbing the inhabitants with the sound perceived as noise. This enables the number of inland wind power plants to be Increased even in populated regions and the proportion of regeneratively generated energy in the energy mix of a region to be increased without the residents and consumers thus being disturbed. In particular, the proportion of locally generated energy for neighboring consumers can thus be increased, as a result of which power losses as a result of energy transmission over long distances can be avoided.

A further aspect of the invention relates to a method for manufacturing a tooth, which can be designed and refined as described above, and/or a toothed element, which can be designed and refined as described above, in which a tooth, the tooth shape of which is based on evolvent teeth or cycloid teeth, is provided on at least one tooth flank with a periodically extending tooth flank correction and a spatial microstructure superimposed on the tooth flank correction, wherein the tooth flank correction is created by a mechanical chip-removing method, in particular grinding, polishing, and/or honing, The tooth flank correction can take place in a conventional manner without the creation of the microstructures having a negative influence thereon. The increase of the white noise in the structure-borne sound emitted from the tooth with the aid of the microstructures enables a reduction of noise emissions disturbing to humans in torque transmission units.

The microstructures are preferably created chronologically after the creation of the tooth flank correction. Additionally or alternatively, the creation of the base shape of the tooth and the creation of the tooth flank correction can take place at least partially simultaneously. This enables teeth with tooth flank correction to be produced in mass production and, only for those applications in which noise disturbance for humans due to emitted structure-borne sound threatens to occur, the microstructure to be created in an additional finishing step. In applications in which noise disturbance for humans is not a concern, for example in wind power gears intended for offshore wind power plants, the finishing step of creating microstructures can be dispensed with. This enables cost-efficient production.

The microstructures are particularly preferably created by embossing, laser machining, and/or eroding. With embossing, structures can be mechanically created in the surface of the tooth flank existing after the tooth flank correction, for example by piercing, scoring, flanging, and/or pressing or rolling a negative form of the microstructure. A part of the surface of the tooth flank can be removed, for example by vaporization, in particular by laser machining by way of a punctiform Introduction of energy. The size and/or the depth and possibly the local energy introduction can be set easily via suitable focusing of a laser beam. With the aid of laser machining, nearly any formations and distributions of maxima and minima can be created for the microstructure. With eroding, for example, a part of the material of the tooth can be removed from the surface of the tooth flank by spark erosion with the aid of a locally limited introduction of energy. With chemical erosion, this can be carried out by a chemical reaction, for example by etching.

A further aspect of the invention relates to a computer program product comprising commands which, when the program is executed by a data processing device of a machine tool, cause it to carry out the method which can be designed and refined as described above. The increase of the white noise in the structure-borne sound emitted from the tooth with the aid of the microstructures enables a reduction of noise emissions disturbing to humans in torque transmission units.

One aspect further relates to a data agglomerate comprising data packets which are combined in a common file or distributed across different files and are intended for representing the three-dimensional formation and/or the interactions of all constituent parts provided in the tooth, which can be designed and refined as described above, or in the toothed element, which can be designed and refined as described above, wherein the data packets are prepared so as, when they are processed by a data processing device for operating a machine tool for additive manufacturing of devices, to additively manufacture the constituent parts of the tooth and/or toothed element, in particular by 3D printing, and/or, when they are processed by a data processing device for carrying out a technical simulation, to carry out a simulation of the functioning of the tooth and/or toothed element and output thus generated simulation results for further use, in particular in order to provide a verification of the fatigue strength as a function of variable loads and/or variable thermal loading, and if appropriate to compare them with measurement data determined on a device according to the invention that has been produced in reality and/or on a prototype of the device according to the invention. The data packets of the data agglomerate are specially adapted to the configuration according to the invention of the device in question according to the invention as described above, in order to be able to adequately represent the Interaction according to the invention between the constituent parts of the device according to the invention when they are processed in the data processing device. The data packets may in particular be stored with a spatial distribution, but may also be aligned with one another such that if all the data packets are brought together in a common data processing device, the thus composed data agglomerate provides all the required data for an additive manufacture and/or a technical simulation using the data processing device for the device according to the invention. For example, the data packets are each separate parts of a data library, which are brought together to form the data agglomerate and aligned with one another with respect to their dimensions relative to one another and/or absolute dimensions and/or material properties corresponding to the device in question according to the invention. The data agglomerate can represent a virtual embodiment of the device in question according to the invention in the manner of what is referred to as a “digital twin”, which allows a virtual investigation in the form of a simulation or a real objectification by means of an additive manufacturing process. Such a digital twin is presented for example in US 2017/286572 A1, the disclosure contents of which are hereby referred to as part of the invention.

When the data processing device of the machine tool processes the data agglomerate, the device according to the invention is produced such that, after the data agglomerate has been processed in the data processing device, the device according to the invention is obtained, at least in the form of a prototype. In particular, a data packet can in each case represent a separate constituent part of the respective associated device according to the Invention, and therefore the Individual constituent parts can be easily actually and/or virtually assembled in their relative position and/or relative movability to realize the interactions that are essential to the invention. In particular, it is possible, with the aid of the respective data packets, to generate the different constituent parts of the respective device separately and optionally from different materials by additive manufacturing and subsequently to assemble them to form a prototype of the device in question. The division of the data of the data agglomerate into different data packets thus makes possible, in straightforward fashion, a sequential additive manufacture of constituent parts, which are movable relative to one another, of the device in question in the form of a kit of parts, which is prepared to be assembled merely as expedient for the interaction according to the invention of the constituent parts of the prototype for solving the problem addressed by the invention.

Additionally or alternatively, it is possible, using the data packets of the data agglomerate, in a virtual environment during a technical simulation, to calculate and/or predict the individual constituent parts of the respective device and their Interactions, the physical state and/or the change of physical parameters depending on different boundary conditions and/or over the time of the associated device according to the invention and to continue to use them for checking whether the device according to the invention is suitable enough for the intended use on the basis of the hypothetical configuration and taking into account the hypothetical simulated influences. When the data agglomerate is processed by a data processing device representing the simulation environment, it is possible to be able to investigate the behavior of the device according to the invention, taking into account in particular changing boundary conditions. This makes it possible, for example, to investigate possible centrifugal force effects on individual constituent parts of the device according to the invention depending on different static and/or dynamic loads and/or different operating temperatures, with it being possible for such simulation results to be incorporated into the establishment of a fatigue strength verification. Preferably, the simulation results obtained after the data agglomerate has been processed in the data processing device for the simulation environment are stored in order to compare them with measurement data determined on a device according to the invention that has been produced in reality and/or on a prototype of the device according to the invention. This makes it possible to assess the quality of the simulation results obtained with the aid of the data agglomerate and/or, in particular in the case of particularly strong deviations, to identify measurement errors and/or an erroneous measurement. This simplifies and improves non-destructive quality control of the device according to the invention.

The data agglomerate enables cost-effective production of prototypes and/or cost-effective computer-based simulations to study the functioning of the tooth and/or the toothed element, identify problems in the specific use case and find improvements. The solution to the problem addressed by the invention can be easily and cost-effectively checked using the data agglomerate.

Below, the invention will be explained by way of example with reference to the appended drawings on the basis of preferred exemplary embodiments, wherein the features presented below may in each case individually or in combination represent an aspect of the invention. When a feature is presented in combination with another feature in the specific exemplary embodiment, this serves only for simplified presentation of the invention on the basis of the exemplary embodiment and is in no way to mean that this feature cannot also be a refinement of the invention without the other feature, wherein the scope of protection of the invention is defined by the independent claims. It is shown in:

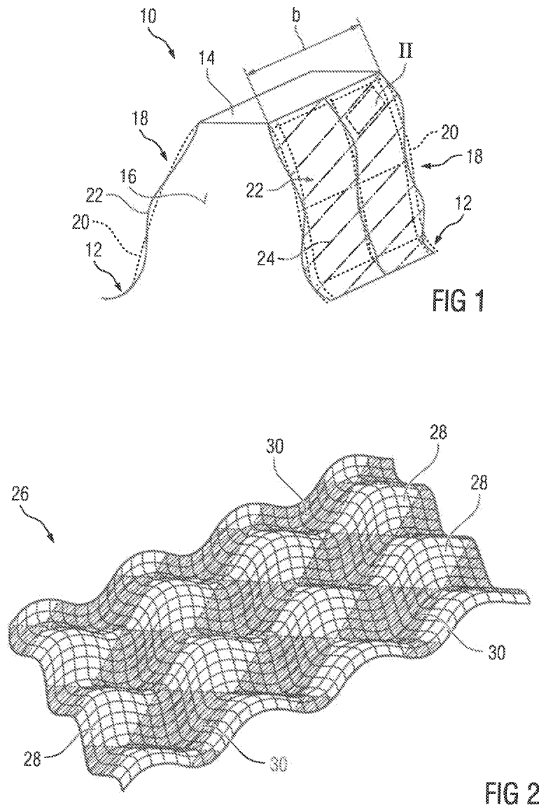

FIG. 1: a schematic perspective view of a tooth,

FIG. 2: a schematic detailed view of detail II from FIG. 1,

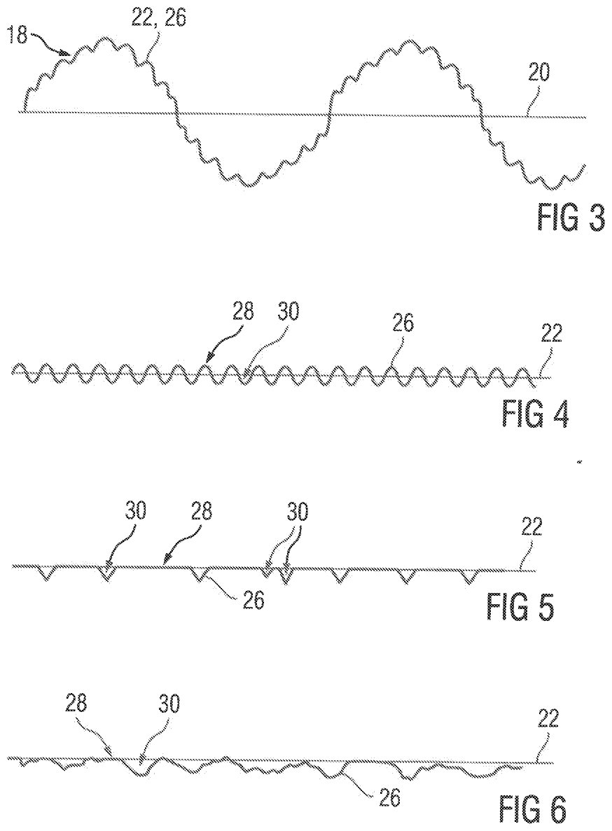

FIG. 3: a schematic sectional view of the tooth from FIG. 2 in a tooth flank development,

FIG. 4: a schematic sectional view of the tooth from FIG. 2 in a tooth flank correction development,

FIG. 5: a schematic sectional view of a first alternative to the tooth from FIG. 2 in a tooth flank correction development,

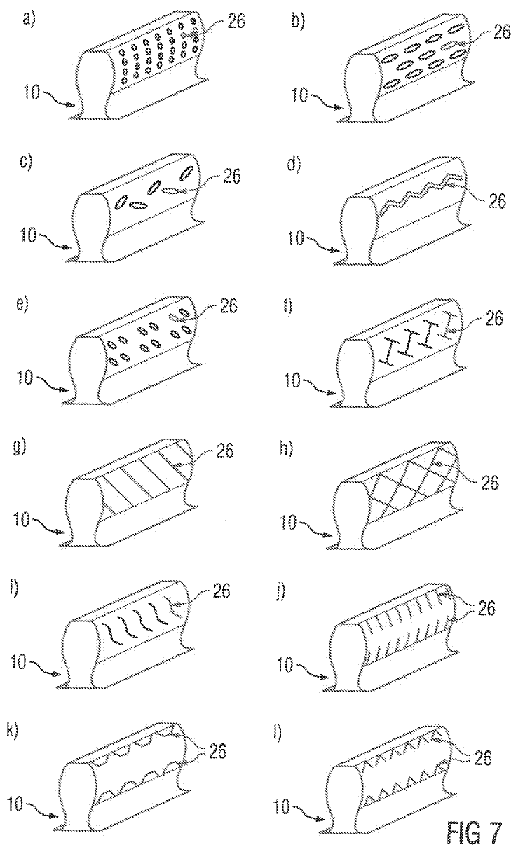

FIG. 6: a schematic sectional view of a second alternative to the tooth from FIG. 2 in a tooth flank correction development,

FIG. 7a)-l): show schematic perspective views of a tooth with various formations of microstructures,

FIG. 8: a schematic qualitative representation of an image range of an FFT of a frequency spectrum of a wind power gear with standard teeth, and

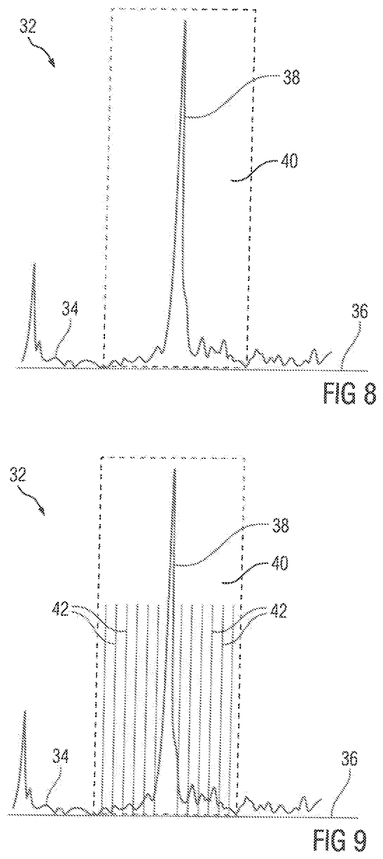

FIG. 9: a schematic qualitative representation of the frequency spectrum from FIG. 8, which could result in a wind power gear having teeth according to the invention.

The tooth 10 shown in FIG. 1 can in particular be part of a gear wheel for a wind power gear of an (inland) wind power plant, in which an impairment to humans by noise is to be avoided. The tooth 10 has a base 12, which can be integrally connected to a disk-shaped body of a gear wheel, and a head 14 facing radially outward. The base 12 and the head 14 can be connected via end face 16, which faces in the axial direction. Moreover, the base 12 and the head 14 can be connected via tooth flanks 18 facing in the tangential direction. In the Illustrated exemplary embodiment, the tooth 10 has a base shape 20 as is used for evolvent teeth. At least one tooth flank 18, preferably both tooth flanks 18, are provided with a standardized tooth flank correction 22, which is a periodically extending waveform in the exemplary embodiment shown. In the exemplary embodiment shown, a wave front of the tooth flank correction 22 designed as a waveform extends slightly obliquely in relation to a width b of the tooth 10, so that straight lines 24 extending through respective in-phase points of the waveform also extend obliquely. Alternatively, the tooth flank correction 22 can be designed as an arbitrary tooth flank correction 22 according to ISO 21771[:2007].

As the base shape 20 of the tooth 10 is overlaid by the tooth flank correction 22, the tooth flank correction 22 is in turn overlaid by a microstructure 26, which is shown in detail in FIG. 2. In the tooth flank correction development, the tooth flank correction 22 defines a center line which is used as a reference for the formation of the microstructure 26. The detail shown in FIG. 2 shows a part of the tooth flank 18 which extends over approximately 90% of a quarter period duration (T/4) of the tooth flank correction 22 designed as a waveform. In the exemplary embodiment of the microstructure 26 shown for simplified explanation in FIG. 2, maxima 28 and minima 30 are arranged in a rectangular row and column structure, in particular like a chessboard and/or comparable to tiles, alternately adjacent to one another and one behind another. Alternatively, the microstructure 26 can have, for example, only maxima 28, only minima 30, or both maxima 28 or also minima 30. The maxima 28 and minima 30 can follow a sine structure, wherein the maxima 28 in the minima 30 each have precisely equal distances t to one another and precisely equal deflections a and also occupy precisely equal surface areas within the tooth flank 18. The course of the rows and columns of the microstructure 26 is preferably aligned obliquely in relation to the wavefront of the tooth flank correction 22 and the straight line 24. Such a microstructure 26 can be produced, for example, by embossing a rolling negative form on the surface of the tooth flank 18 existing after the creation of the tooth flank correction 22.

As shown in FIG. 3, a shaky course results for the tooth flank correction 22 due to the superimposed microstructure 26, which results due to the interference of the microstructure 26 having a significantly smaller period duration and significantly smaller amplitude in comparison to the period duration and amplitude of the tooth flank correction 22 designed as a waveform. As shown in FIG. 4, the microstructure 26 can have a sinusoidal course.

As shown in FIG. 5, the microstructure 26 can also have a non-sinusoidal course, for example in that the minima 30 of the microstructure 26 were created by laser machining or spark erosion. The distances between the minima 30 can be equal, so that a periodic but not sinusoidal course results for the microstructure. The distances between the minima 30 are preferably different in size and arbitrarily provided within defined limits. In particular, the depth of the respective minima 30 is different. The maxima 28 of this microstructure 26 can be defined by those areas between the minima 28 in which no material removal has taken place during the creation of the microstructure 26.

As shown in FIG. 6, the microstructure 26 can also be formed strongly arbitrarily and randomly distributed with respect to the position of the maxima 28 and minima 30 and also their size and depth or height. Such a microstructure 26 can be created, for example, by chemical erosion, for example by etching.

As shown in FIG. 7a)-l), the microstructure 26 can have many different formations and/or patterns. The respective tooth 10 can in particular be embodied with or also without tooth flank correction 22 according to ISO 21771[:2007]. The respective microstructure 26 can have, for example, only maxima 28, only minima 30, or both maxima 28 or also minima 30, wherein the maxima 28 and minima 30 can in particular be arranged alternately to one another. However, it is also possible that the shortest distance t is defined by two successive maxima 28 and/or minima 30.

As shown in FIG. 8, a frequency spectrum 32 of a wind power gear having standard teeth determined according to IEC 61400-11 can have an amplitude course 34 over a frequency 36. In this case, a specific frequency stands out clearly with respect to its amplitude in comparison to the other frequencies and represents a tonality 38 in the measured emitted structure-borne sound. Only frequencies having very low amplitude are present in a frequency range 40 around the tonality 38.

As shown in FIG. 9, in comparison to the frequency spectrum 32 shown in FIG. 8, multiple secondary frequencies 42 can be generated by the teeth 10 according to the invention in the manner of white noise within the frequency range 40 around the tonality 38 as the main frequency. These secondary frequencies 42 are lower in their amplitude than the tonality in the range of the main frequency, but greater than most other frequencies in the frequency spectrum 32. If the tonality 38 as the main frequency is so loud that it is audible, the secondary frequencies 42 are also sufficiently audible to mask the tonality. The secondary frequencies 42 can form side bands for the tonality 38, so that the bandwidth of the tonality 38 broadens in the image range of the FFT, which is only indicated for reasons of simplified representation of the secondary frequencies 42 in FIG. 9, however, deviating from the representation actually resulting in the image range of the FFT,

1.-15. (canceled)

16. A tooth for a toothed torque transmission assembly, the tooth comprising:
a tooth flank designed for torque exchange with a counter flank of a meshing partner, said tooth flank comprising a periodically extending tooth flank correction including a sinusoidal corrugation having a locally extending period length T, wherein a development of the sinusoidal corrugation of the periodically extending tooth flank correction defines a center line,
wherein the periodic tooth flank correction is overlaid with a spatial microstructure having a local maxima and/or a local minima and a shortest distance t of t<T/2 between the local maxima and/or the local minima with respect to the center line, and
wherein a formation of the microstructure is dimensioned to generate additional structure-borne sound in running operation of the torque transmission assembly to mask a tonality in the emitted structure-borne sound.

17. The tooth of claim 16, wherein 0.00005≤1/T≤0.49, in particular 0.0001≤t/T≤0.05, preferably 0.0005≤t/T≤0.01, and particularly preferably 0.001≤UT≤0.005.

18. The tooth of claim 16, wherein the tooth flank correction has an amplitude A in a direction of a surface normal of a non-tooth-flank corrected tooth flank, and wherein the microstructure has a deflection a in relation to the center line of the tooth flank correction in a direction of a surface normal of the tooth flank, wherein 0.00005≤a/A≤0.50, in particular 0.0001≤a/A≤0.10, preferably 0.0005≤a/A≤0.05, and particularly preferably 0.001≤a/A≤0.01.

19. The tooth of claim 16, wherein the tooth flank correction and the microstructure extend Identically in an area both in a width direction and in a length direction of the tooth flank, in particular an entire tooth flank, wherein the width direction extends parallel to a designated axis of rotation of an associated gear wheel und the length direction extends from a tooth base to a tooth head, and wherein the width direction and the length direction are aligned essentially at a right angle to one another.

20. The tooth of claim 16, wherein a course of the microstructure over the tooth flank correction is formed aperiodically, In particular arbitrarily and/or randomly distributed.

21. The tooth of claim 16, wherein the microstructure is designed such, that in a comparison of a tooth with microstructure with an otherwise identical tooth without microstructure, a Fast Fourier Transform of a structure-borne sound emitted from the tooth with microstructure, with an otherwise identical torque transmission in a same toothed torque transmission assembly, has a greater bandwidth of at least one frequency maximum of the tonality in an image range of the Fast Fourier Transform.

22. The tooth of claim 16, wherein the tooth flank is based on a straight-toothed or helical-toothed base shape for evolvent teeth or cycloid teeth.

23. A toothed element, in particular a gear wheel or toothed rack, for a toothed torque transmission assembly having a plurality of teeth, the toothed element comprising the tooth of claim 16, wherein the tooth flank correction has an amplitude in a direction of a surface normal of a non-tooth-flank corrected tooth flank and the microstructure has a deflection in relation to a center line of the tooth flank correction in a direction of a surface normal of the tooth flank, wherein differently formed microstructures are formed for at least one toothed flank of various teeth with respect to their distance and/or their deflection and/or wherein the periodically extending tooth flank correction of the teeth is formed substantially differently, in particular with respect to a period length and/or a phase offset between the teeth.

24. The toothed element of claim 23, wherein toothed flanks with differently formed microstructures have a substantially equal mean roughness and/or a substantially equal square roughness,

25. A wind power gear for a wind power plant, in particular erected in inhabited space, comprising the toothed element of claim 23.

26. A method for manufacturing a tooth or a toothed element, the method comprising:
providing a tooth, which has a tooth shape based on evolvent teeth or cycloid teeth, on at least one tooth flank with a periodically extending tooth flank correction and a spatial microstructure superimposed on the tooth flank correction,
wherein the tooth flank correction is created by a mechanical chip-removing method, in particular grinding, polishing, and/or honing.

27. The method of claim 26, further comprising creating the microstructure chronologically after creation of the tooth flank correction.

28. The method of claim 26, further comprising creating the microstructure by embossing, laser machining, and/or eroding.

29. A computer program product comprising a computer program embodied on a non-transitory computer readable medium comprising commands which, when the computer program is executed by a data processing device of a machine tool, cause the data processing device to carry out the method of claim 26.

30. A data agglomerate, comprising data packets combined in a common file or distributed across different files and intended for depicting a three-dimensional formation and/or interactions of all constituent parts provided in the tooth of claim 16 or in a toothed element having said tooth,
wherein the data packets are prepared so as during processing by a data processing device for operating a machine tool for additive manufacturing of devices, to additively manufacture the constituent parts of the tooth and/or the toothed element, in particular by 3D printing, and/or,
wherein the data packets are processed by a data processing device for carrying out a technical simulation, to carry out a simulation of a functioning of the tooth and/or the toothed element and output thus generated simulation results for further use, in particular in order to provide a verification of a fatigue strength as a function of variable loads and/or variable thermal loading.
